(19) United States
(12) Patent Application Publication
(10) Pub. No.: US 2019/0102471 A1
(43) Pub. Date: Apr. 4, 2019

(54) GUIDED TOUR DESIGNER

(71) Applicant: ServiceNow, Inc., Santa Clara, CA (US)

(72) Inventors: Aditya Ramamurthy, Hyderabad (IN); Rohit Sengar, Hyderabad (IN); Raghavan Muthuraman, Hyderabad (IN)

(21) Appl. No.: 15/724,074

(22) Filed: Oct. 3, 2017

(51) Int. Cl. G06F 17/30; G06F 3/0485; G06F 3/0481; G06F 3/0483

(52) U.S. Cl. CPC G06F 17/30873; G06F 3/0485; G06F 17/3089; G06F 3/0483; G06F 3/04812

(57) ABSTRACT

Systems, methods, and media are provided that present a page designer interface that enables the design of a page in a service interface. The page in the service interface may provide a support interface that enables users to report issues or receive technical support. A creation or selection of an element of the page in the page designer interface may enable content to be displayed related to the element. The content may be displayed in a guided tour. The guided tour is presented when the page is accessed in the service interface. For example, the guided tour may autoplay when the page is accessed. An analytics interface provides analytics of previous invocations of the guided tour.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Computer resources hosted in distributed computing (e.g., cloud-computing) environments may be disparately located with each having its own functions, properties, and/or permissions. Such resources may include hardware assets, such as computing devices, switches, and the like. Additionally or alternatively, the resources may include software assets, such as database applications, application programming interfaces (APIs), and the like. In a distributed computing environment, hardware assets and software assets may be geospatially separated. The process of managing assets may include, for example, debugging systems or communicating with the customers on methods to interact with and/or request the assets. Communicating with customers regarding how to interact with the assets of a distributed computing environment may be difficult as the customer may be geospatially separated from the assets and/or potential support facilities. Furthermore, merely leaving the customer/user to self-determine how to utilize support may be inefficient and/or difficult for the customer/user.

### BRIEF DESCRIPTION OF THE DRAWINGS

The description herein makes reference to the accompanying drawings, wherein like reference numerals refer to like parts throughout the several views.

FIG. 1 is a block diagram of a distributed computing system, in accordance with an embodiment;

FIG. 2 is a block diagram of a computing device utilized in the distributed computing system of FIG. 1, in accordance with an embodiment;

FIG. 3 is a flow diagram of an instruction designing process, in accordance with an embodiment;

FIG. 4 is a screen of a page designer interface that facilitates the instruction designing process of FIG. 3, in accordance with an embodiment;

FIG. 5 is a screen illustrating the selection of an autoplay function, in accordance with an embodiment;

FIG. 6 is a screen illustrating different user domains, in accordance with an embodiment;

FIG. 7 is a screen illustrating different user roles, in accordance with an embodiment; and

FIG. 8 is a screen illustrating an analytics interface with sample data, in accordance with an embodiment; and

FIG. 9 is a flow diagram of a process for creating a guided tour, in accordance with an embodiment

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Information Technology (IT) devices are increasingly important in an electronics-driven world in which various electronic devices (e.g., hardware assets, software assets) are interconnected within a distributed context. As an increasing number of functions are performed through users interacting with electronic devices using a common platform to coordinate activity between individual users, the complexity of IT network management increases. A service interface may be provided to users as a mechanism to detail issues (e.g., incident reports) to be supported and/or to receive technical support. As these devices and computing centers are separated geospatially, managing these devices through the service interface may become more difficult. In such an interconnected but distributed context, the ability to communicate how to utilize the service interface may be central to performing the task in a more efficient manner than may be accomplished via traditional communication methods. Communicating how to perform a task in a page (e.g., create incident report page) of the service interface may be facilitated by a page designer interface that enables the design of the page in a service interface, where instructions may be presented on the page to instruct how to interact with the page when the page is accessed in an interactive user interface.

Through the design of the page in the service interface, elements of the page may be selected via instructions from memory. A selected page element may present an instruction-providing interface. The instruction-providing interface may be designed to receive inputs that are to be presented as instructions when the page is accessed in an interactive user interface. The instructions presented when the page is accessed through the interactive user interface may be text-based instructions, but may also be image-based instructions, audio-based instructions, video-based instructions, and/or additional media-based instructions. The page designer interface and the instruction-providing interface may have certain accessibility accommodations. For example, the ability to navigate through the page designer interface and/or the instruction-providing interface using only keyboard strokes (e.g., tab keystroke, enter keystroke). For example, a first receipt of a keyboard stroke (e.g., tab) may be used to open a callout box, and a second receipt of the keyboard stroke may be used to advance to a next element in the page. When the page designer interface interaction is completed, settings from the instruction-providing interface may be saved to the page in the service interface for later access as a guided tour. The page designer interface may also present an auto-presentation menu that enables selection of an autoplay option that may allow the guided tour to play automatically when the page is accessed in the interactive user interface.

The interactive user interface may be accessed through different classifications of users which may be created through different combinations of user domains and user roles. The differences between the interactive user interfaces may result in the guided tour appearing in the interactive user interface for one classification of user or environment (i.e., domain) but not for a second classification of user or environment. Indeed, in some embodiments, a different guided tour may be provided for the second classification.

When the page and/or the corresponding guided tour(s) is accessed in the interactive user interface, the accessing action becomes a previous invocation of the page and/or the guided tour. An analytics interface may be used to provide the analytics of data related to the previous invocations of the page and/or guided tour, where the previous invocations may have occurred. The analytics interface may enable the tracking and aggregation of the data over time. The analytics interface, for example, may provide the data on the number of users or environments who accessed the page, number of guided tour sessions completed, average duration of guided tour sessions, and/or the number of sessions.

In this way described, communicating how to perform a task may be facilitated using the page designer interface that enables the design of one or more elements of the page, where an instructions-providing interface related to the one or more elements of the page may be presented as instructions when the page is accessed in an interactive user interface, and where the instructions may guide the user through a task or set of tasks related to the page in a more efficient manner than may be accomplished via traditional communication methods (e.g., traditional tutorials).

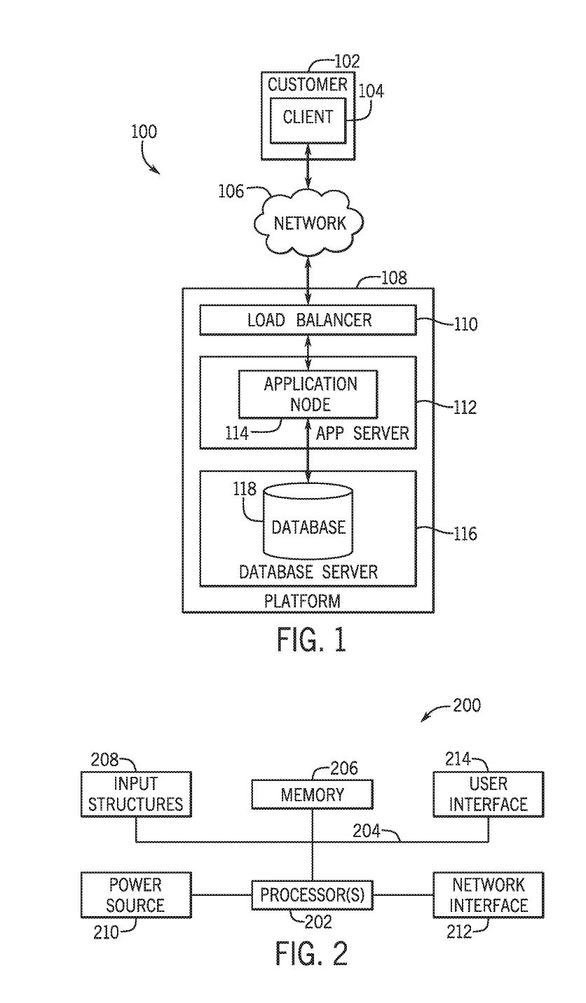

By way of introduction, FIG. 1 is a block diagram of an example of an electronic computing and communications system 100, hereinafter the system 100, in accordance with the present disclosure. As used herein, the term “electronic computing and communications system,” or variations thereof, may be, or include, a distributed computing system (e.g., a client-server computing system), a cloud computing system, a clustered computing system, or the like.

The system 100 may include one or more customer environments 102, each which may include one or more clients 104. The client 104 may include a computing system which may include one or more computing devices, such as a mobile phone, a tablet computer, a laptop computer, a notebook computer, a desktop computer, or any other suitable computing device or combination of computing devices. In some embodiments, the client 104 may be implemented on a single physical unit or on a combination of physical units. In some embodiments, a single physical unit may include multiple clients.

In some embodiments, the client 104 may be an instance of an application running on a customer device associated with the customer environment 102. As used herein, the term “software” may include, but is not limited to, applications, programs, instances, processes, threads, services, plugins, patches, application version upgrades, or any other identifiable computing unit capable of accessing or interacting with, directly or indirectly, a database. The system 100 may include any number of customer environments 102 or clients 104 or may have a configuration of customer environments 102 or clients 104 different from that generally illustrated in FIG. 1. For example, the system 100 may include hundreds or thousands of customer environments 102, and at least some of the customer environments 102 may include or be associated with any number of clients 104. A customer environment 102 may include a customer network or domain. For example, the client 104 may be associated or communicate with a customer network or domain.

The system 100 may include a platform 108. The platform 108 may include one or more servers. For example, the platform 108, as generally illustrated, includes an application server 112 and a database server 116. A datacenter, implementing at least a portion of the platform 108, may represent a geographic location, which may include a facility, where the one or more servers are located. The system 100 may include any number of datacenters and servers or may include a configuration of datacenters and servers different from that generally illustrated in FIG. 1. For example, the system 100 may include tens of datacenters, and at least some of the datacenters may include hundreds or any suitable number of servers. In some embodiments, the platform 108 may be associated or communicate with one or more datacenter networks or domains, which may include domains other than the client domain.

In some embodiments, the client 104 and the servers associated with the platform 108 are configured to connect to, or communicate via, a network 106. In some embodiments, the network 106 may include the Internet. Additionally or alternatively, in some embodiments, the network 106 may include a local area network (LAN), a wide area network (WAN), a virtual private network (VPN), or any other public or private means of electronic computer communication capable of transferring data between the client 104 and one or more servers associated with the platform 108, or a combination thereof. The network 106, the platform 108, or any other element, or combination of elements, of the system 100 may include network hardware such as routers, switches, load balancers, other network devices, or combinations thereof. For example, the platform 108 may include a load balancer 110 for routing traffic from the network 106 to various servers associated with the platform 108.

The load balancer 110 may route computing communication traffic to respective elements of the platform 108. For example, the load balancer 110 may operate as a proxy or reverse proxy, for a service, such as an Internet-delivered service, provided by the platform 108 to one or more remote clients 104 via the network 106. Routing functions of the load balancer 110 may be configured directly or may utilize a Domain Name System (DNS)-based scheme. The load balancer 110 may coordinate requests from remote clients 104 to simplify client 104 access by masking the internal configuration of the platform 108 from the remote clients 104 and/or to provide numerous potential destinations (e.g., servers) via a single address to provide the platform 108 the ability to manage burdens on hardware in the platform 108.

Although the load balancer 110 is depicted in FIG. 1 as being within the platform 108, in some embodiments, the load balancer 110 may additionally or alternatively be located outside of the platform 108.

In some embodiments, the platform 108 includes an application server 112 and a database server 116. The application server 112 and/or the database server 116 may include a computing system, which may include one or more computing devices, such as a desktop computer, a server computer, or any other computer capable of operating as a server. In some embodiments, the application server 112 or the database server 116 may be a dedicated server and/or a virtual server. In some embodiments, the platform 108 may include servers other than or in addition to the application server 112 or the database server 116.

In some embodiments, the application server 112 includes an application node 114, which may include a process executed on the application server 112. For example, the application node 114 may be executed in order to deliver services to the client 104 as part of a web application. The application node 114 may be implemented using processing threads, virtual machine instantiations, and/or other computing features of the application server 112. In some embodiments, the application node 114 may store, evaluate, or retrieve data from a database 118 of the database server 116.

In some embodiments, the application server 112 may include any suitable number of application nodes. In some embodiments, the number of application nodes running may by dynamic. For instance, the number may vary depending upon a system load or other characteristics associated with the application server 112. Moreover, the application server 112 may include two or more nodes forming a node cluster. In some embodiments, the application nodes implemented on a single application server 112 may run on different hardware servers associated with the platform 108.

The database server 116 stores, manages, or otherwise provides data for delivering services to the client 104 over the network 106. In some embodiments, the database server 116 includes the database 118 as a data storage unit. The database 118 may be accessible by the application node 114. In some embodiments, the database 118 may be implemented as a relational database management system (RDBMS), an object database, an XML database, a configuration management database (CMDB), a management information base (MIB), one or more flat files, other suitable non-transient storage mechanisms, or a combination thereof. By way of non-limiting example, the system 100, in some embodiments, may include an XML database and a CMDB. While limited examples are described, the database 118 may be configured to include any suitable database type. Further, the system 100 may include one, two, three, or any suitable number of databases of any suitable database type or combination thereof.

In some embodiments, one or more databases (e.g., the database 118), tables, other suitable information sources, or portions or combinations thereof may be stored, managed, or otherwise provided by one or more of the elements of the system 100 other than the database server 116, such as the client 104 or the application server 112.

In some embodiments, the systems and techniques described herein, portions thereof, or combinations thereof may be implemented on a single device, such as a single server, or a combination of devices, for example, a combination of the client 104, the application server 112, and the database server 116.

In some embodiments, the system 100 may include devices other than the client 104, the load balancer 110, the application server 112, and the database server 116 as generally illustrated in FIG. 1. In some embodiments, one or more additional servers may operate as an electronic computing and communications system infrastructure control, from which servers, clients, or both servers and clients, may be monitored, controlled, configured, or a combination thereof.

In any case, to perform one or more of the operations described herein, the client 104, the application server 112, and other server or computing system described herein may include one or more of the computer components depicted in FIG. 2. FIG. 2 generally illustrates a block diagram of example components of a computing device 200 and their potential interconnections or communication paths, such as along one or more busses. As briefly mentioned above, the computing device 200 may be an embodiment of the client 104, the application server 112, a database server 116, and other servers in the platform 108. As previously noted, these devices may include a computing system that includes multiple computing devices and/or a single computing device, such as a mobile phone, a tablet computer, a laptop computer, a notebook computer, a desktop computer, a server computer, and/or other suitable computing devices.

As illustrated, the computing device 200 may include various hardware components. For example, the device includes one or more processors 202, one or more busses 204, memory 206, input structures 208, a power source 210, a network interface 212, an interactive user interface 214, and/or other computer components useful in performing the functions described herein.

The one or more processors 202 may include processor capable of performing instructions stored in the memory 206. For example, the one or more processors may include microprocessors, system on a chips (SoCs), or any other performing functions by executing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206. Moreover, the functions of the one or more processors 202 may be distributed across multiple processors in a single physical device or in multiple processors in more than one physical device. The one or more processors 202 may also include specialized processors, such as a graphics processing unit (GPU).

The one or more busses 204 includes suitable electrical channels to provide data and/or power between the various components of the computing device. For example, the one or more busses 204 may include a power bus from the power source 210 to the various components of the computing device. Additionally, in some embodiments, the one or more busses 204 may include a dedicated bus among the one or more processors 202 and/or the memory 206.

The memory 206 may include any tangible, non-transitory, and computer-readable storage media. For example, the memory 206 may include volatile memory, non-volatile memory, or any combination thereof. For instance, the memory 206 may include read-only memory (ROM), randomly accessible memory (RAM), disk drives, solid state drives, external flash memory, or any combination thereof. Although shown as a single block in FIG. 2, the memory 206 can be implemented using multiple physical units in one or more physical locations. The one or more processor 202 accesses data in the memory 206 via the one or more busses 204.

The input structures 208 provide structures to input data and/or commands to the one or more processor 202. For example, the input structures 208 include a positional input device, such as a mouse, touchpad, touchscreen, and/or the like. The input structures 208 may also include a manual input, such as a keyboard and the like. These input structures 208 may be used to input data and/or commands to the one or more processors 202 via the one or more busses 204. The input structures 208 may alternative or additionally include other input devices. For example, the input structures 208 may include sensors or detectors that monitor the computing device 200 or an environment around the computing device 200. For example, a computing device 200 can contain a geospatial device, such as a global positioning system (GPS) location unit. The input structures 208 may also monitor operating conditions (e.g., temperatures) of various components of the computing device 200, such as the one or more processors 202.

The power source 210 can be any suitable source for power of the various components of the computing device 200. For example, the power source 210 may include line power and/or a battery source to provide power to the various components of the computing device 200 via the one or more busses 204.

The network interface 212 is also coupled to the processor 202 via the one or more busses 204. The network interface 212 includes one or more transceivers capable of communicating with other devices over one or more networks (e.g., network 106). The network interface may provide a wired network interface, such as Ethernet, or a wireless network interface, such an 802.11, Bluetooth, cellular (e.g., LTE), or other wireless connections. Moreover, the computing device 200 may communicate with other devices via the network interface 212 using one or more network protocols, such as Transmission Control Protocol/Internet Protocol (TCP/IP), power line communication (PLC), WiFi, infrared, and/or other suitable protocols.

An interactive user interface 214 may include a display that is configured to display images transferred to it from the one or more processors 202. The display may include a liquid crystal display (LCD), a cathode-ray tube (CRT), a light emitting diode (LED) display, an organic light emitting diode display (OLED), or other suitable display. In addition and/or alternative to the display, the interactive user interface 214 may include other devices for interfacing with a user. For example, the interactive user interface 214 may include lights (e.g., LEDs), speakers, haptic feedback, and the like.

As such, there may be an example of a customer environment 102, where the customer environment 102 may include a service interface (e.g., available from SERVICENOW® using the NOW PLATFORM®) to facilitate the navigation of an application associated with the client 104. The service interface may be displayed to the customer environment 102 via the interactive user interface 214. The customer environment 102 may perform a task on the service interface through the couplings described. For example, the service interface may be used to make requests through service catalogs, access application development tools, generate ad hoc snapshots of current data, to save/share/publish/export reports from data, submit a complaint, submit a technology work order). A second client outside the customer environment 102 may be separated geospatially from the client 104 and may be used to manage the service interface, but such management of the service interface may become more difficult due to the geospatial separation. To address such separation, the ability of the service interface developers and/or managers to communicate how to perform a task in the service interface to the customer environment 102, may be facilitated by the design of a page and/or page elements in a service interface of the device or the computing center. Through the design of the page in the service interface, elements of the page may be selected using the input structures 208 of a customer environment 102 as a way to create a sequential guide (e.g., a guided tour) that may be presented as instructions on the page. The sequential guide may be initiated to provide guidance when and where instructions are to be used (e.g., while the users are using the page).

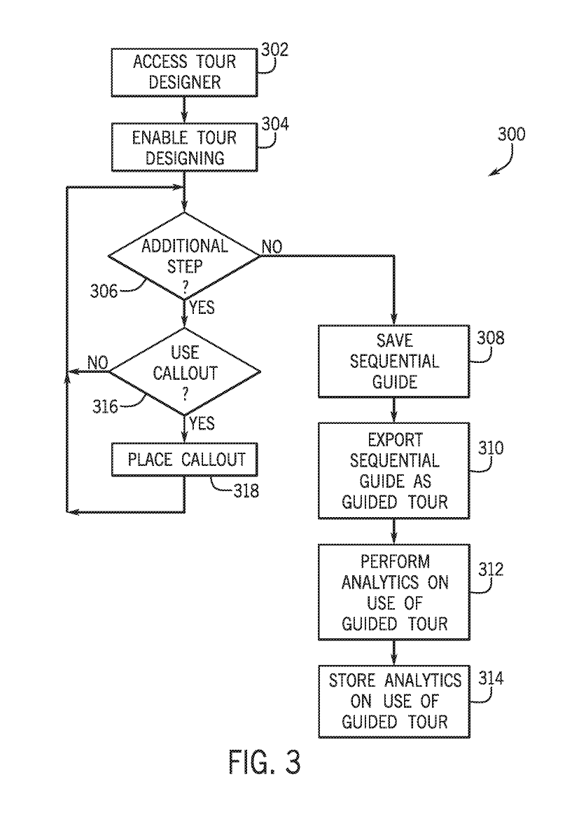

FIG. 3 illustrates a process 300 to design the elements of the page in the service interface to be accessed as the sequential guide on the page.

A tour designer (e.g., SERVICENOW® Guided Tour Builder) is accessed through the input structures 208 (block 302). The tour designer may utilize a page designing interface. In some embodiments, the tour designer may be accessed through a page of the service interface. For example, in some embodiments, the tour designer may be accessed by service interface developers and/or managers. Application and organizational implementations may dictate which roles have access to the tour designer through their environments. The tour designer may be used to create sequential guides for reference by the client 104. When the tour designer is accessed, the tour designer of the service interface may be displayed via interactive user interface 214 and be interacted with via input structures 208.

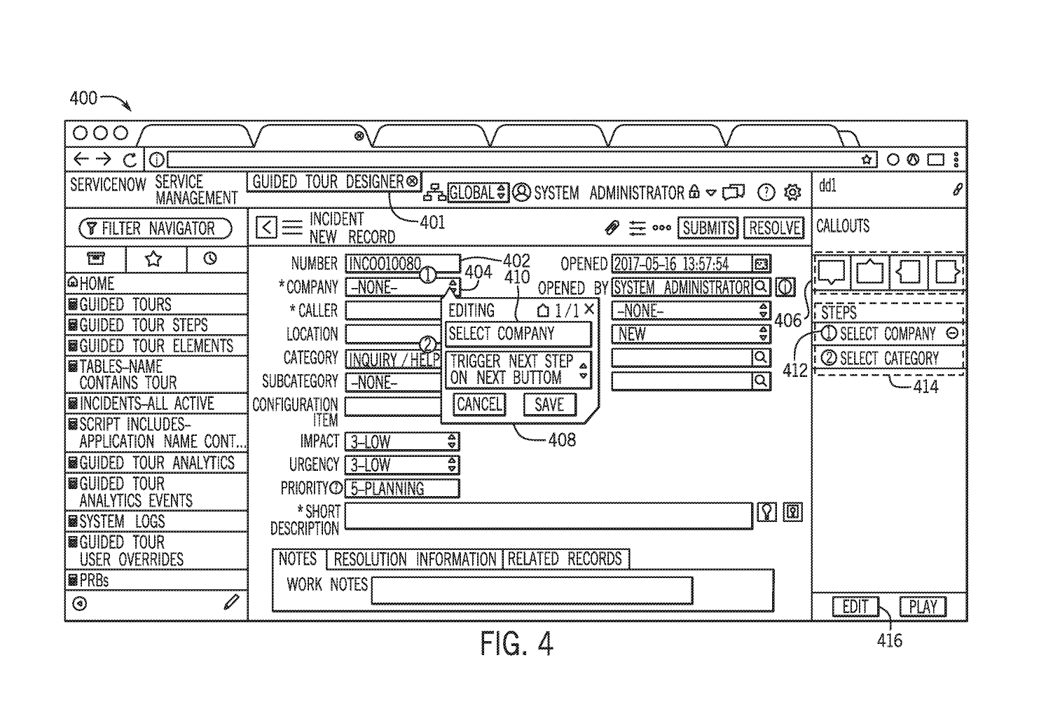

Tour designing may be enabled through an indication received via the input structures 208 and, subsequently, received by the processor 202 (block 304). The activation of tour designing may occur through interaction with the interactive user interface 214 via the input structures 208. When tour designing is enabled, a page, which may be similar to page 400 of FIG. 4, may be displayed as the current page accessed in the service interface.

As FIG. 4 illustrates, there may be an indication that tour designing is enabled. In this embodiment, editing indicator 401 shows that tour designing is enabled for page 400. In this embodiment, page elements, like element 402 and element 404, may be selected during tour designing and used to create a sequential guide to be accessed via page 400 as a guided tour after the sequential is associated with the page 400. Page elements, like elements 402 and 404, may include editable-fields and/or otherwise interactive aspects on the page 400. These editable-fields and/or otherwise interactive aspects, for example the number field of element 402 and the company field of element 404, on the page may be selected and may be used to create the sequential guide.

To select a page element, a callout orientation options 406 box may be provided to select between available callout box orientations. A callout box 408 is moved, dragged, or otherwise associated with the selected page element. When an indication of selection is received, a callout box 408 may appear associated with the selected page element. For example, the illustrated callout box 408 appears associated with element 404. The callout box 408 may be a callout shape of variable size and orientation. In some embodiments, the orientation may be set using the callout orientation options 406.

When placed, the callout box 408 may receive inputs. In some embodiments, the inputs may be similar to editable text 410. The inputs received may alter how a step of the sequential guide is described when it is accessed as a guided tour. The step of the sequential guide may be designed to act like an explanation of the step and may be a text-based explanation. Additionally or alternatively, the explanation may be image-based, audio-based, video-based, and/or additional media-based explanations. As such, the callout box 408 may vary in size based on the content of the explanation of the callout box 408. For example, a larger amount of editable text 410 may cause the callout box 408 to appear to be larger than a callout box 408 displaying a smaller amount of editable text 410. The callout orientation options 406 of the callout box 408 may be shown with more than one of the callout box orientation option. In this way, the callout orientation options 406 may include a right direction callout box. Additionally or alternatively, callout orientation options 406 may include an up direction, a down direction, and/or a left direction. In some embodiments, the orientation for the callout box 408 may be determined through selecting the orientation by associating the orientation from the callout boxes orientations. In some embodiments, the orientation may be determined automatically through a smart callout placement option that determines which direction from the selected element provides sufficient space to place the callout box 408. For example, sufficient space may exist when more than a threshold distance (e.g., size of callout box) exists between the page element and an edge of the page. If more than one direction includes sufficient space, a priority of orientations may be selected. For example, a left-pointing orientation may be prioritized and selected when there are available options that include the left-pointing orientation. Additional orientations not described may be used to associate a callout box 408 with a selected element 404.

Callout box 408 and associated inputs may appear in a step listing 414. The step listing 414 may describe the order of steps of the sequential guide, and may allow reordering of the steps. In some embodiments, a step label 412 indicates where the corresponding step falls in an order of the sequential guide, a summary description of the input associated, and/or the step associated with the callout box 408.

During tour designing, the order of the step listing 414 may be altered until an appropriate order for the sequential guide is reached. When the sequential guide is complete, the sequential guide may be associated and/or saved to the page 400. The association/saving may be through the exit button 416, or through an additional exit/save/export button not illustrated on FIG. 4. Once association occurs of the sequential guide to the page 400, a user may access the sequential guide, presented as a guided tour, when they access the page 400.

Returning to FIG. 3, to design an order/presentation of page elements that may be presented in the sequential guide when the page is accessed, the processors 202 may check for an indication of the page element identified as the first step of the sequential guide (block 306). Page elements may include editable-fields and/or otherwise interactive aspects on the page accessed through the tour designer, similar to the elements 402 and 404 as described above. Indications of which page element may be may be used to create the sequential guide may occur through the interaction using the input structures 208 through the interactive user interface 214, resulting in the indication from the input structure 208 to be transmitted to the processor 202.

When the page element is selected and the indication of the selection is transmitted to the processor 202, the processor 202 may check for an indication of whether to place a callout (block 316). The indication of whether to place an instruction-providing interface (e.g., callout box 408) may occur through the interaction between the input structure 208 and interactive user interface 214 resulting in the indication from the input structure 208 to be transmitted to the processor 202.

The action of placing the callout may allow a callout shape (e.g., callout box 408) to be moved, dragged, or otherwise associated with the selected page element (e.g., selected element 404). Upon associating the callout shape with the selected page element, the processor 202 may receive an indication of the callout placement, and may enable a callout to be placed (e.g., callout box 408) (block 318). When placed, the callout may receive inputs (e.g., editable text 410). The inputs received may alter how a step of the sequential guide is described (e.g., step label 412). The step of the sequential guide may be designed to act like an explanation of the step and may be a text-based explanation. Additionally or alternatively, the explanation may be image-based, audio-based, video-based, and/or additional media-based explanations. Additionally or alternatively, the placement and/or orientation (e.g., the direction the callout indicates toward) of the callout is determined with respect to the page element as the purpose of the callout may be to facilitate the description of the step of the sequential guide. The callout placement and orientation may be set by the service interface developers and/or managers to suit the application or may be dynamically selected using an dynamic selection process. Dynamic selection may enable the use of a calculation to find the space between the callout and the edge of the page to automatically determine a callout placement. For example, a determination may be made as to whether the more space is available to the left, right, above, and/or below the page element. Furthermore, in some embodiments, a side (e.g., right) of the page element may be preferred as long as a distance from the page element to an edge of the page is above a threshold distance. Additionally or alternatively to the space available determination, dynamic selection may be used to perform the callout placement. Orientation may vary based on automatic placement locations. Additionally or alternatively, orientation options (e.g., callout orientation options 406) may be provided.

Returning to FIG. 3, when an additional step is added, it may be indicated independent of the indication of callout placement. The inclusion of additional steps and placements of callouts continue until no indications of further additions are made. The additional steps and callouts may appear tour designer as a step listing (e.g., step listing 414 in FIG. 4).

The processor 202 may receive an indication to save the designed sequential guide (block 308). In some embodiments, the sequential guide may be saved when the tour designer interface is closed/disabled. In some embodiments, the sequential guide may be saved automatically without receiving the indication from the input structure 208. The saving of the sequential guide may be performed through the interactive user interface 214 to indicate the completion of the design of the sequential guide. The action in the interactive user interface 214 may be the result of receiving via the input structure 208 a press of a button, a close of a window, and/or otherwise indicate in the tour designer that the design of the sequential guide may be saved (e.g., exit button 416 in FIG. 4). In response to such performance to finish the tour design, the indication received via the input structure 208 may be transmitted to the processor 202.

With tour designing saved, the sequential guide may be exported as a guided tour (block 310). The sequential guide may be exported in response to a received indication received via the guide tour designer interface and transmitted to the processor 202. Moreover, the steps of the sequential guide may be exported as a guided tour to the relevant and associated page of the service interface. In some embodiments, the exporting and saving functions may be performed with the same indication to processor 202.

Once exported, the sequential guide may be accessed as a guided tour through the page in the service interface by the customer environment 102. In some embodiments, the guided tour may be accessed via uniform resource locator (URL) address (e.g., web address). If accessed via URL address, the URL address may link to the guided tour. The URL address may provide a direct method to communicate the particular guided tour between user via email, instant messaging, and other forms of communication. Any additional users that have the URL and have rights to access the page may access the guided tour via the URL.

As a guided tour, the steps of the sequential guide may be presented as a dynamic and/or intuitive representation of the sequential guide to instruct how to utilize the page. In this way, the guided tour adds movement to a standard sequential guide. The guided tour may allow the steps of the sequential guide to appear transposed on the page of the service interface. As such, through the guided tour, the service interface developers and/or managers may be able to incrementally communicate to the customer environment 102 instructions on how to use the page of the service interface they are interfacing with.

To communicate instructions to potential users, the guided tour may display the callout associated to the current step of the sequential guide as a design which is visually related to the element the step was associated with (e.g., a callout adjacent to the element of the step, similar to the callout box 408). When a predetermined amount of time has passed in the guided tour, an indication to proceed to the next step of the sequential guide is received, and/or the proper action performed by the user has been completed (e.g., action-triggered step), the displayed callout of the current step may disappear and/or an additional callout of the current step or of the next step may appear on the page. In this way, the guided tour may proceed through the steps of the sequential guide as designed in the tour designer. In this way, the guided tour may communicate the message of how to use the page from the service interface developers and/or managers to potential users.

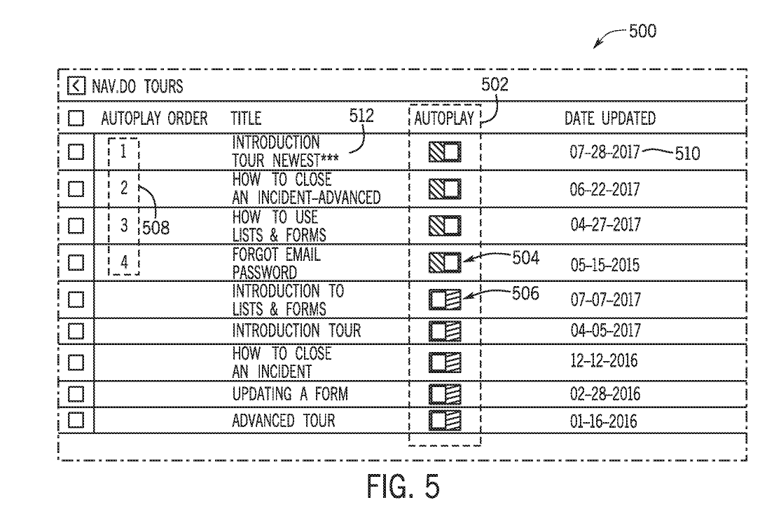

In some embodiments, when the page is accessed in the service interface, the guided tours linked to the page may begin presentation automatically. FIG. 5 illustrates an autoplay page 500 through which the autoplay option 502 for one or more guided tours may be accessed. The autoplay option 502 may enable selection of guided tours to be begun automatically when a user visits the page associated with the autoplay page. Selectable elements 504 and 506 (e.g., a slider, radio button, etc.) enables the selection of the autoplay option 502. When a selectable element is enabled, illustrated with selectable element 504, the design presented in the tour designer changes (e.g., changing color to indicate the change between states, making a sound to indicate the change between state, changing a shape of the selectable element). The enabled state, illustrated with selectable element 504, may differ from the disabled state, illustrated with selectable element 506. Furthermore, in some embodiments, the guided tours in the autoplay page may be sorted into enabled and disabled portions. In such embodiments, when an autoplay is disabled, it may be moved from the selectable elements 504 to the selectable elements 506 regardless of original location.

When the selectable element 504 is operated to the enabled state, the steps of the sequential guide that are linked to the selectable element 504 may be automatically started when the page is accessed in the user interface. In this way, the steps of the sequential guides linked to the multiple enabled selectable elements of the autoplay option 502 may automatically begin in a particular order as sequentially-played guided tours. The particular order of the sequentially-played guided tours may be indicated by the autoplay order option 508. In some embodiments, the autoplay order option 508 may be determined by the service interface developers and/or managers. When the processor 202 receives instructions via the guided tour designer interface, the autoplay order option 508 may be updated to reflect that the changes have been stored. To update the autoplay order option 508, an indication of the change may be stored in the memory 206.

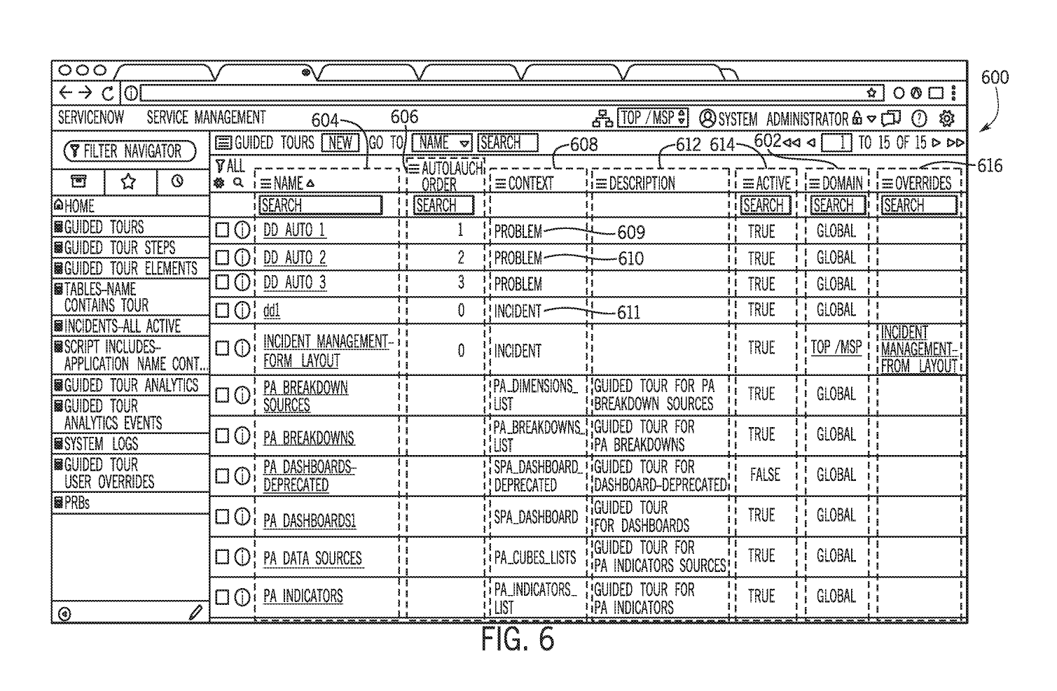

The steps of the sequential guide linked to the selectable elements 506 will not be operated to autoplay as guided tour when the page is accessed in the user interface since the selectable element 506 corresponds to a disabled state, as illustrated. In some embodiments, the sequential guide linked to the selectable element 506 may be accessed as a guided tour through the page despite not appearing in the auto-presentation menu of the page. For example, available guided tours may be manually selectable on the page via an instruction-presenting interface. In some embodiments, an indication of the date of the most recent update to the guided tour may be stored. The date of the most recent update may be displayed, similar to date updated field 510. In some embodiments, a title may be assigned to the guided tour. As such, the title may appear similar to title field 512 to differentiate guided tours. In some embodiments, potential users may access the guided tour if they access the page from a first domain but may not access the page if they access the page from a second domain. FIG. 6 illustrates a guided tours menu 600 including a domain option 602 which may serve to limit access to the guided tour. The domain option 602 (e.g., user domain option) may indicate the logically-defined user domain through which the guided tour may be accessed.

Domains may be programmed to separate data as a method to enforce data segregation between two separate business entities, business units of the same business, or may allow for the customization of business process definitions and user interfaces between the domains. In this way, domains may allow access to separate data between users based on what domain the user is assigned to. Users may be automatically assigned to the global domain and users of a particular domain may see the data of their domain in addition to the data of their child domains.

As such, from the tour designer, the domain option 602 specifies which domains (e.g., all domains through global designation) may access the guided tour. When the domain option 602 is updated, an indication of the change may be stored in memory 206, the client 104, the application server 112, and/or the database server 116, depending on the application. As illustrated, there may be more than one user domain option to assign to the guided tour. For example, in the illustrated embodiment of the guided tours menu 600, the domain options 602 include a global domain and a TOP/MSP domain.

Additionally illustrated is a name field 604, which may show the name and/or the title of the guided tours. In some embodiments, an autolaunch order option 606 may be indicative of the order presented with the autoplay order option 508. As illustrated, some embodiments may have a context field 608 that may serve to categorize and/or to organize guided tours based on content of the guided tour. A guided tour 609 may have similar content to a guided tour 610 but different content to a guided tour 611, based on the content field 608. As illustrated, some embodiments may have a description field 612 that may summarize the purpose and/or content of the guided tour in a more specific way that the context field 608. In some embodiments, an active field 614 may display the status of the guided tour. If a guided tour is active, the active field 614 may show true, and if a guided tour is inactive, the active field 614 may show false. System overrides defining certain field settings different from the default field setting may also be displayed in some embodiments, similar to setting displayed in the override field 616.

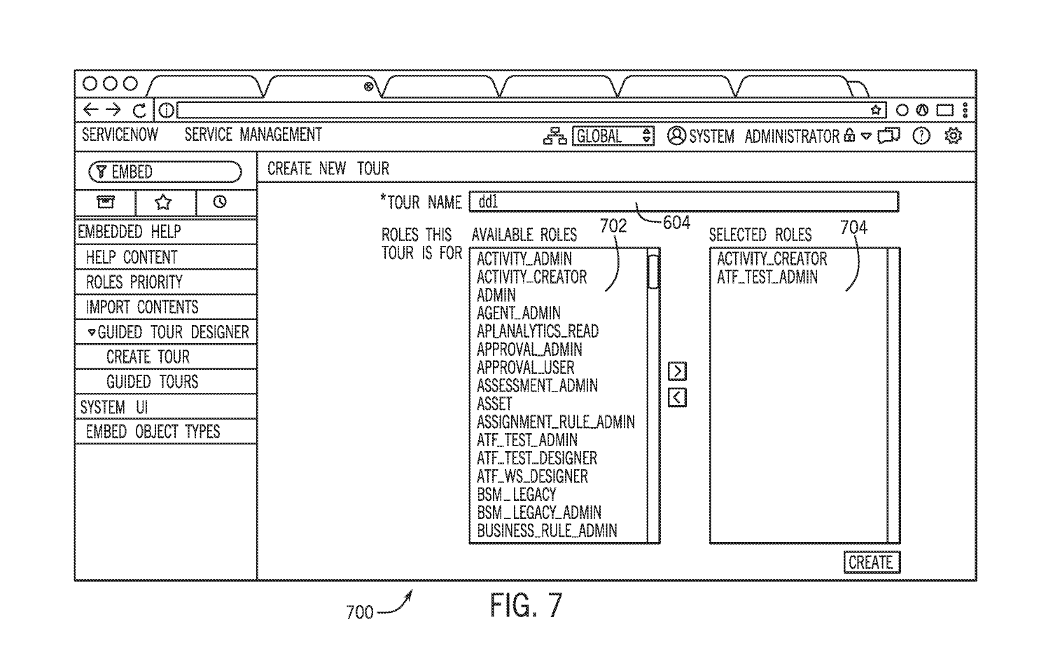

In some embodiments, different user roles may be assigned to the user that may be serve to further limit access of the guided tours. FIG. 7 illustrates the selection of user roles which may access the guided tour when the page is accessed through the service interface. Tour designer screen 700 shows an example page of the tour designer, illustrating a number of user roles that may be granted access to the guided tour. Available user roles to select from may be illustrated by user roles 702, while the selected subset of user roles from the user roles 702 may be illustrated as selected user roles 704. The selected user roles 704 may represent the user roles that may be granted access to the guided tour when a customer assigned to at least one of the selected user roles 704 accesses the guided tour. For example, if a user was assigned the user role of activity_creator, the user may access the guided tour when accessing the corresponding page in the service interface to obtain technical support. Conversely, if the user was assigned the user role of approval_admin, the user may not have access to the guided tour.

In some embodiments, when access to the guided tour is denied to the user, the guided tour may not appear through the page of the service interface. In some embodiments, the guided tour may appear on the page of the service interface but may inform the user that the access of the guided tour has been denied (e.g., through pop-up window, message window). Additionally or alternatively, the guided tour may autorun for some roles but may be available for manual initiation by the user. In some embodiments, when access of the guided tour is granted to the user, the guided tour may automatically start upon access of the page of the service interface. In some embodiments, when access of the guided tour is granted to a user, the guided tour may be accessed through the page without automatically starting (e.g., manual initiation). In some embodiments, the user may have the option to dismiss a guided tour that has automatically started, which may prevent the guided tour from automatically playing in additional accessing attempts. The option to dismiss a guided tour may, in some embodiments, be given only to a subset of user roles or domains.

Returning to discussions on FIG. 3, the settings associated with providing or denying access to a particular guided tour (e.g., domain option 602, selected user roles 704) and/or the autoplay option 502, may be updated during the export of the sequential guide to the page as a guided tour (block 310). The settings may, for example, be stored in memory 206, the database server 118, the application server 112, and/or in the client 104. The settings may be accessed when there is an attempt to access the page by a user. The settings may determine which guided tours associated with the page would be appropriate to allow the user and/or customer environment 102 to access.

When the guided tour is initiated in the interactive user interface (block 312), the accessing action becomes a previous invocation of the guided tour. Data regarding the previous invocations may be stored (block 314). For example, the data may be stored in memory 206, the database server 118, the application server 112, and/or in the client 104. The data stored may be examined in order to draw conclusions about the information that may be represented by the data stored. Examination of the data stored may be performed through data analytics routines and/or facilitated by systems (e.g., SERVICENOW® Performance Analytics). Data analytics routines may be operated to provide insight into how to improve the quality of business services and processes. As such, data analytics routines may be used to analyze the data stored regarding the interaction with the guided tour by the user in order to determine deficiencies and/or to improve the quality of services (e.g., business services and processes) provided. An analytics interface may communicate the results of the data analytics routines to service interface developers and/or managers through display of the data stored. The analytics interface enables the tracking and aggregation of data stored over time and may allow the changes to be communicated via display of the data stored. In some embodiments, the display of the data stored may be updated after each previous invocation. Additionally or alternatively, in some embodiments, the display of the data stored may be updated when the analytics interface is accessed and/or using a manual update initiated in the analytics interface.

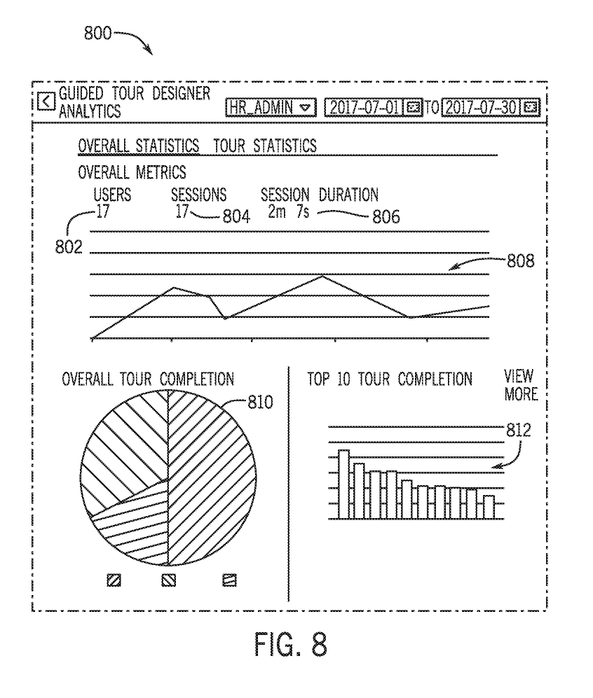

FIG. 8 illustrates how data analytics routines may be communicated to a user (e.g., a service interface developer and/or manager) interested in analyzing the data regarding the interaction of the other users with the guided tour. A screen 800 may show the results of the data analytics routines. The results may be displayed on the screen 800. In some embodiments, the data analytics routine may result in an indication 802 of a number of users who accessed a guided tour. In some embodiment the data analytics routine may result in the indication 804 of a number of sessions which included accessing a guided tour. In some embodiment the data analytics routine may result in an indication 806 of an average session duration of the sessions. In some embodiment the data analytics routine may result in an embedded chart 808 may be used to show the number of sessions over a period of time (e.g., per month). In some embodiment the data analytics routine may result in an embedded chart 810 showing the percentage of guided tours which were dismissed (e.g., 0% viewed), completed (e.g., viewed from beginning to end of guided tour or 100% viewed), or partially completed (e.g., dismissed and/or exited at a certain time which represents a percentage of the whole, where the percentage viewed is not 0% or 100%). In some embodiments, the data analytics routine may result in an embedded chart 812 showing a selection (e.g., highest percentage completed) of guided tours based on the average percentage completed. The results of the data analytics routines may include a variety of results that originate from data collected from a previous invocation. Averaging functions, performance indicating functions, thresholding functions, index scoring functions, and/or formulas building predictive indicators may all be valid applications of the data stored regarding the interaction of the customer environment 102 with the guided tours.

In some embodiments, certain accessibility protocols may be followed (e.g., Web Content Accessibility Guidelines 2.0). As such, the tour designer interface and/or the service interface may have certain accessibility accommodations, for example, the ability to navigate through the tour designer using only keyboard strokes (e.g., tab keystroke, enter keystroke). For example, a first receipt of a keyboard stroke (e.g., tab) may be used to open a callout box, and a second receipt of the keyboard stroke may be used to advance to a next element in the page. As an additional or alternative example, the tour designer and/or the service interface may be compatible with diverse access methods, such as alternative keyboards, assistive input devices, screen readers, braille keyboards, and/or voice commands.

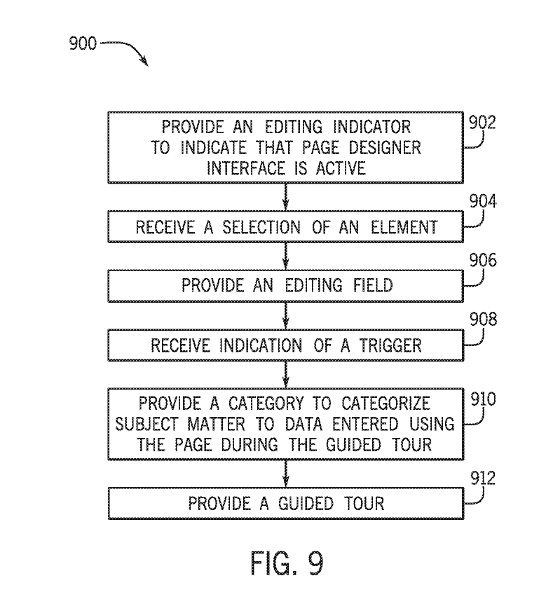

In this way, a process 900 illustrated in FIG. 9 summarizes the method of creating a guided tour using the page designer interface. The process 900 may be at least partially executed by the processor(s) 202 of the client 104 and/or the application node 114 by executing instructions in memory 206 of the client 104 and/or the application node 114. To enable the page designer interface, the processor 202 may provide an editing indicator 401 that indicates that a page designer interface is active (block 902). The page designer interface enables the design/configuration of at least one element of the page in the service interface and/or customer environment 102. For example, in some embodiments, the page designer interface may be used to design a complete page or application to create guided tours on their application form or list. The processor 202 may receive indication of the selection of the element of the page in the page designer interface to be edited (block 904). The processor 202 may provide an editing field when indication of selection of an element is received (block 906). The editing field may receive content that may be presented in a guided tour. The content that may be received by the editing field may be the same content that is presented when the page is accessed and/or is presented in an autorun mode. The autorun mode may be activated for the guided tour in an auto-presentation menu. The processor 202 may receive an indication of trigger (block 908). The trigger may result in the next step of the guided tour to be presented, after the content associated with the element is presented. The indication of trigger may be specifying to the processor 202 what action performed during the guided tour would result in the trigger of the next step. The processor 202 may be provided a category to categorize subject matter of data entered using the page during the guided tour (block 910). The processor 202 may provide the guided tour, created with the page designer interface, highlighting the content associated with the element (block 912).

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system comprising:
one or more processors; and
memory storing instructions that, when executed, are configured to cause the one or more processors to:
provide an editing indicator that indicates that a page designer interface is active, wherein the page designer interface is configured to enable design of at least one element of a plurality of elements in a page in a service interface;
receive a selection of an element of the at least one element of a page in the page designer interface to be edited;
provide an editing field configured to receive content that is to be presented automatically in a guided tour including the content when the page is accessed and an autorun mode is activated for the guided tour in an auto-presentation menu;
receive an indication of a trigger that triggers a next step in the guided tour after the content associated with the element;
provide a category to categorize subject matter of data entered using the page during the guided tour; and
provide the guided tour comprising the content.

2. The system of claim 1, wherein the content comprise text, image, video, or a combination thereof.

3. The system of claim 2, wherein the text comprises textual instructions for interacting with the element during the guided tour, the image comprises visual instructions for interacting with the element during the guided tour, and the video comprises video instructions for interacting with the element during the guided tour.

4. The system of claim 1, wherein the instructions are configured to cause the one or more processors to receive the content via the editing field.

5. The system of claim 1, wherein instructions are configured to cause the one or more processors to:
cause a callout box including the editing field to be displayed upon determination that a first keyboard stroke has been received; and
receive a selection of a next element of the plurality of elements upon determination that a second keyboard stroke has been received.

6. The system of claim 1, wherein the instructions are configured to cause the one or more processors to present an analytics interface that provides analytics of previous invocations of the guided tour.

7. The system of claim 6, wherein the analytics interface comprises information regarding a completion percentage of the previous invocations of the guided tour or an indication of which tours have been completed by highest percentages.

8. The system of claim 6, wherein the analytics interface comprises a number of users that have accessed the previous invocations of the guided tour or an average session duration of the previous invocations of the guided tour.

9. The system of claim 1, wherein the instructions are configured to cause the one or more processors to present a domain separation interface that enables the guided tour to be specified as available for users from a first domain but unavailable to users of a second domain.

10. The system of claim 1, wherein the instructions are configured to provide the editing field based at least in part on available space around the element.

11. The system of claim 1, wherein the instructions are configured to:
receive a selection of a subsequent element of the plurality of elements; and
provide a subsequent editing field configured to receive subsequent content to be presented in the guided tour after the content has been presented and the trigger has occurred.

12. A method comprising:
presenting a page designer interface configured to enable design of a page in a service interface configured to provide a support interface that enables users to report issues or receive technical support;
receiving a selection of an element of a page in the page designer interface;
receiving content to be displayed relative to the element in a guided tour;
receiving an identification of a trigger configured to proceed to a next step after displaying the content; and
presenting the guided tour when the page is accessed, when the guided tour is flagged with an autoplay option configured to cause the content to autoplay when the page is accessed.

13. The method of claim 12, wherein the next step after displaying the content comprises: displaying subsequent content, or
ending the guided tour.

14. The method of claim 12, wherein causing the content to autoplay when the page is accessed comprises displaying the content after previous content in the guided tour.

15. The method of claim 12 comprising presenting an analytics interface that provides analytics of previous invocations of the instructions, wherein the analytics comprise information regarding a completion percentage of the previous invocations of the guided tour, an indication of which tours have been completed by the highest percentages, a number of users that have accessed the previous invocations of the guided tour, or an average session duration of the previous invocations of the guided tour.

16. The method of claim 12 comprising presenting an autoplay menu that is configured to receive the flagging for the autoplay option for the guided tour.

17. The method of claim 12 comprising presenting an autoplay menu that is configured to receive an autoplay order of a plurality of guided tours associated with the page, wherein the plurality of guided tours comprises the guided tour.

18. A system comprising:
one or more processors; and
memory storing instructions that, when executed, are configured to cause the one or more processors to:
present a page designer interface configured to enable design of a page in a service interface configured to provide a support interface that enables users to report issues or receive technical support;
receive a selection of an element of a page in the page designer interface;
receive content to be displayed relative to the element in a guided tour;
present the guided tour when the page is accessed, when the guided tour is flagged with an autoplay option configured to cause the content to autoplay when the page is accessed; and
present an analytics interface that provides analytics of previous invocations of the guided tour.

19. The system of claim 18, wherein the instructions are configured to cause the one or more processors to present a user role separation interface that enables the guided tour to be specified as available for users assigned to a first user role but unavailable to users assigned to a second user role.

20. The system of claim 18, where the instructions are configured to cause the one or more processors to:
present the analytics comprising information regarding a completion percentage of the previous invocations of the guided tour, an indication of which tours have been completed by highest percentages, a number of users that have accessed the previous invocations of the guided tour, or an average session duration of the previous invocations of the guided tour.
